(19) United States
(12) Patent Application Publication
(10) Pub. No.: US 2026/0115838 A1
(43) Pub. Date: Apr. 30, 2026

(54) METHOD AND SEPARATING DEVICE FOR SEPARATING AT LEAST ONE WORKPIECE FROM A RESIDUAL GRID OF A RESIDUAL GRID ASSEMBLY OF PARTS

(71) Applicant: TRUMPF Werkzeugmaschinen SE + Co. KG, Ditzingen (DE)

(72) Inventors: Patrick Mach, Korb (DE); Stefan Krause, Wilthen (DE)

(21) Appl. No.: 19/430,381

(22) Filed: Dec. 23, 2025

Related U.S. Application Data
(63) Continuation of application No. PCT/EP2024/068417, filed on Jun. 30, 2024.

(30) Foreign Application Priority Data
Jun. 30, 2023 (DE) 102023117371.5

(51) Int. Cl. B23K 26/70; B23K 37/04

(52) U.S. Cl. CPC B23K 26/70; B23K 37/0408

(57) ABSTRACT

A method for separating at least one workpiece from a residual grid of a residual grid assembly of parts which is produced from a plate-shaped material by a cutting process, the method including feeding the residual grid assembly of parts to a holder of a separating device together with a holding-down element resting on an upper side of the residual grid assembly of parts. The method further includes jointly exciting and thereby vibrating the holding-down element and the residual grid assembly of parts by a vibration drive. The holding-down element is configured to enable the at least one workpiece to be separated in a targeted manner only downward with respect to a bottom side of the residual grid assembly of parts.

### CROSS REFERENCE TO RELATED APPLICATIONS

This application is a continuation of International Application No. PCT/EP2024/068417 (WO 2025/003507 A1), filed on Jun. 30, 2024, and claims benefit to German Patent Application No. DE 10 2023 117 371.5, filed on Jun. 30, 2023. The aforementioned applications are hereby incorporated by reference herein.

### FIELD

The invention relates to a method for separating at least one workpiece from a residual grid of a residual grid assembly of parts and to a separating device for carrying out the method.

### BACKGROUND

DE 20 2018 001 674 U1 discloses a vibrating table for separating workpieces from a residual grid, wherein the workpieces are held fixed in the residual grid by means of a web connection. The vibrating table comprises a vibrating frame, wherein the vibrating frame is mounted on a frame via springs such that it can vibrate. Vibration drives cause the vibrating frame to vibrate. The residual grid assembly of parts is tensioned onto the vibrating frame by means of clamps. A conveying device is provided below the residual grid assembly of parts. Once the vibrating process is complete, the conveying device is folded down so that the workpieces separated from the residual grid fall down due to the effect of gravity. This vibrating table has the disadvantage that during the vibrating process, workpiece parts that have been separated can also remain above the residual grid so that it is not possible to ensure that all separated workpieces are guided downwards out of the residual grid.

A vibration device is known from US 2016/0023368 A1, the mode of operation of which corresponds to the aforementioned vibrating table.

### SUMMARY

In an embodiment, the present disclosure provides a method for separating at least one workpiece from a residual grid of a residual grid assembly of parts which is produced from a plate-shaped material by a cutting process, the method comprising feeding the residual grid assembly of parts to a holder of a separating device together with a holding-down element resting on an upper side of the residual grid assembly of parts. The method further comprises jointly exciting and thereby vibrating the holding-down element and the residual grid assembly of parts by a vibration drive. The holding-down element is configured to enable the at least one workpiece to be separated in a targeted manner only downward with respect to a bottom side of the residual grid assembly of parts.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a machine arrangement for laser cutting of plate-shaped workpieces using a laser cutting machine and an automation unit with a handling device arranged in front of it;

FIG. 2 illustrates a schematic side view of the handling device above a workpiece support;

FIG. 3 illustrates a schematic side view of the handling device in an arrangement resting on top of the residual grid assembly of parts;

FIG. 4 illustrates a schematic side view of the handling device with the residual grid assembly of parts in a lifted position relative to the workpiece support;

FIG. 5 illustrates a further schematic side view of the handling device for transferring the residual grid assembly of parts to a separating device;

FIG. 6 illustrates a schematic side view of the separating device at the beginning of a separating process;

FIG. 7 illustrates a schematic side view of a state during the separating process;

FIG. 8 illustrates a schematic side view of a further state during the separating process;

FIG. 9 illustrates a schematic side view of the separating device with a separated workpiece;

FIG. 10 illustrates a schematic side view of an embodiment of the separating device; and

FIG. 11 illustrates a schematic side view of an embodiment of the separating device.

### DETAILED DESCRIPTION

The present disclosure provides a method and a separating device for separating at least one workpiece from a residual grid of a residual grid assembly of parts, whereby a controlled and process-reliable separation of the at least one workpiece from the residual grid is made possible.

The foregoing is achieved by a method for separating at least one workpiece from a residual grid of a residual grid assembly of parts, in which the residual grid assembly of parts is fed to a holder of the separating device together with a holding-down element resting on an upper side of the residual grid assembly of parts, in which the holding-down element and the residual grid assembly of parts are jointly excited in the separating device to vibrate by a vibration drive, and in which the holding-down element enables the at least one workpiece separated from the residual grid to be separated in a targeted manner only downward with respect to the bottom side of the residual grid. Positioning the holding-down element above the residual grid assembly of parts ensures that the at least one workpiece separated from the residual grid cannot reach the upper side of the residual grid, but is only guided out downwards, in particular by gravity, in a targeted manner. This means that the workpiece can only be separated from the residual grid in one direction. The separating device can break the web connection, in particular the microjoints or nanojoints, by means of which the workpiece is held fixed to the residual grid. Furthermore, the holding-down element resting on the residual grid has the advantage that a workpiece that may be tilted or jammed in the residual grid, which is completely cut free or tilted or jammed after breaking the web connection, can come loose and be conveyed out downwards due to gravity.

Furthermore, the holding-down element and the residual grid assembly of parts are preferably held together by the holder resting against one another. In particular, the holding-down element and the residual grid assembly of parts can be held together by the holder resting against one another in a clamped manner. As a result, the holding-down element and the residual grid assembly of parts form a unit during the separating process, which is jointly excited to vibrate. This allows for the at least one workpiece to be separated in a quick and safe manner.

Preferably, the vibration drive generates at least one vibration or a back and forth movement which is independent of direction, in particular in a direction perpendicular to the plane of extension of the residual grid assembly of parts and the holding-down element. Due to the reversal of direction in the oscillating back and forth movement of the holding-down element and the residual grid assembly of parts, the inertia of the workpiece allows for a workpiece arranged jammed in the residual grid to first be aligned so that it is transferred from its tilted position to a position resting flat against the holding-down element so that it can then fall freely downwards out of the residual grid. In addition, this step of the workpiece falling out of the residual grid can be supported by a reversal of direction of the vibrating assembly comprising or consisting of the holding-down element and the residual grid assembly of parts.

In order to monitor the separating process, the separation of the at least one workpiece from the residual grid is preferably monitored, preferably by means of a detection device. This can reduce the process time. The vibration drive is activated until the workpieces have been separated from the residual grid assembly of parts. In this context, activation can take place continuously or in pulses. The detection device preferably forwards the detected workpieces to a control device in which the number of workpieces to be separated from the residual grid assembly of parts is known. If not all workpieces have been separated within a predetermined vibration time, the vibration drive is switched off and a corresponding message is issued. If it is detected prematurely at the predetermined vibration time that all workpieces have been separated, the vibration drive is stopped and a message is also issued to the control device.

Advantageously, vibrations are applied to the holder of the separating device directly by the vibration drive. This makes it possible to achieve a high degree of efficiency when breaking the web connection and/or when separating the workpieces, which are cut completely free but may be jammed or tilted in relation to the residual grid.

According to an embodiment of the method, the vibration drive is designed as a vibration conveyor, by means of which the at least one workpiece separated from the residual grid can be conveyed away in a targeted manner. For example, the workpieces can be transferred to storage containers or the like by the vibration conveyor.

Furthermore, the vibration excitation of the vibration drive is preferably introduced into the holding-down element from above or into the residual grid assembly of parts from below.

Furthermore, in addition to the vibration drive, a vibration tool is preferably positioned and activated directly on the holding-down element. This allows an additional vibration excitation to be introduced into the holding-down element so that the vibration introduced by the vibration tool propagates completely in the holding-down element and can be transmitted to the entire residual grid assembly of parts. The vibrations of the vibration tool and the vibration drive can be superimposed.

Advantages of the present disclosure are further achieved by a separating device, in particular for carrying out the method according to any one of the preceding embodiments, which comprises a holder which is provided for receiving the at least one residual grid assembly of parts and a holding-down element resting thereon, and the residual grid assembly of parts and the holding-down element resting thereon can be jointly excited to vibrate by a vibration drive. This separating device enables the holding-down element and the residual grid assembly of parts to be vibrated simultaneously in order to separate the at least one workpiece from the residual grid. Due to the holding-down element resting above the residual grid assembly of parts, the at least one workpiece can only be separated downwards in a targeted manner. This ensures reliable conditions for an automation process.

Preferably, the holder is formed by at least one clamping element or tensioning element. This allows the holding-down element and the residual grid assembly of parts to be firmly positioned and aligned with respect to one another. This also allows for good vibration transmission, in particular during the introduction of vibrations via the holder. Alternatively, a defined distance can be provided between the holder and the holding-down element, for example by means of a damping element, so that a relative movement between the holding-down element and the residual grid assembly of parts is made possible.

The separating device preferably has vibration exciters as a drive device, which control a back and forth movement or an up and down movement in an oscillating manner.

Furthermore, the vibration drive can be designed as a vibration conveyor. This allows the separating device and a transport conveyor device to be integrated with one another. On the one hand, the vibration conveyor allows for the vibration to be excited in order to separate the at least one workpiece from the residual grid and, on the other hand, this vibration excitation allows for the at least one workpiece to be conveyed away.

Preferably, in the case of the vibration drive designed as a vibration conveyor, the holder for receiving the residual grid assembly of parts and the holding-down element is arranged at a distance from the base of the vibration conveyor that corresponds at least to the thickness of the residual grid assembly of parts. This allows the workpiece to be conveyed safely over the base of the vibration conveyor after the at least one workpiece has been separated from the residual grid.

Advantageous embodiments of the present disclosure and developments thereof are described and explained in more detail below by means of the examples illustrated in the drawings. The features that can be derived from the description and the drawings can be used individually or in any combination together according to the present disclosure.

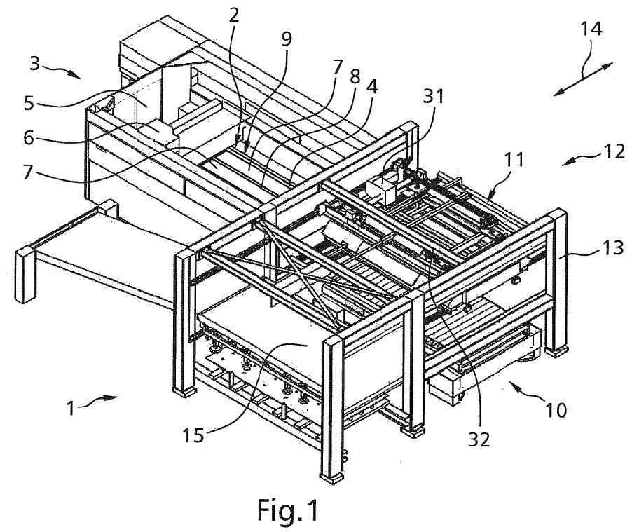

FIG. 1 shows a perspective view of a machine arrangement 1 with a machine tool 3, in which a plate-shaped material 2 is separated by a cutting process using a cutting device into at least one workpiece 7 and one residual grid 8 or multiple residual grid parts. The machine tool 3 is preferably designed as a laser cutting machine.

For the cutting process, the plate-shaped material 2, in particular the metal sheet, is arranged on a workpiece support 15 inside a working region 5 of the machine tool 3. In a known manner, the plate-shaped material 2 is traversed by a laser cutting head 6 of the laser cutting machine for the cutting process. FIG. 1 shows a plate-shaped material 2 inside the working region after the cutting process, in the course of which workpiece blanks or workpieces 7 in the form of finished parts and a residual grid 8 at least partially surrounding the workpiece 7 have been produced as machining products. There is a kerf that is a few millimeters wide between the workpiece 7 and the residual grid 8. The at least one cut workpiece 7 and the residual grid 8 form a residual grid assembly of parts 9. Preferably, the at least one workpiece 7 is completely cut free from the residual grid 8. Alternatively, the workpiece 7 is connected and held in the residual grid 8 by at least one web section, in particular a microjoint or nanojoint.

The workpiece support 15 is provided on a movable pallet 4, which has been moved with the plate-shaped material 2 through a slot-shaped opening in a housing of the machine tool 3 into its working region 5. Previously, the workpiece support 15 with the raw plate-shaped material 2 was deposited at an end face of the machine tool 3 on a conventional pallet changer 10. On the pallet changer 10, the pallet 4 with the workpiece support 15 is moved back after machining the plate-shaped material 2 with the residual grid assembly of parts 9 resting on it. The residual grid assembly of parts 9 is jointly discharged from the pallet changer 10 with a handling device 11 of an automation unit 12.

The handling device 11 is motor-driven and can be moved on a linear device 13 of the automation unit 12 in the direction of a double arrow 14. In this context, the handling device 11 can be moved either via the pallet changer 10 or via a workpiece support 15 arranged to the side of the pallet changer 10. In the example shown, the handling device 11 can also approach a pallet 4 on which unprocessed plate-shaped material 2 is stored.

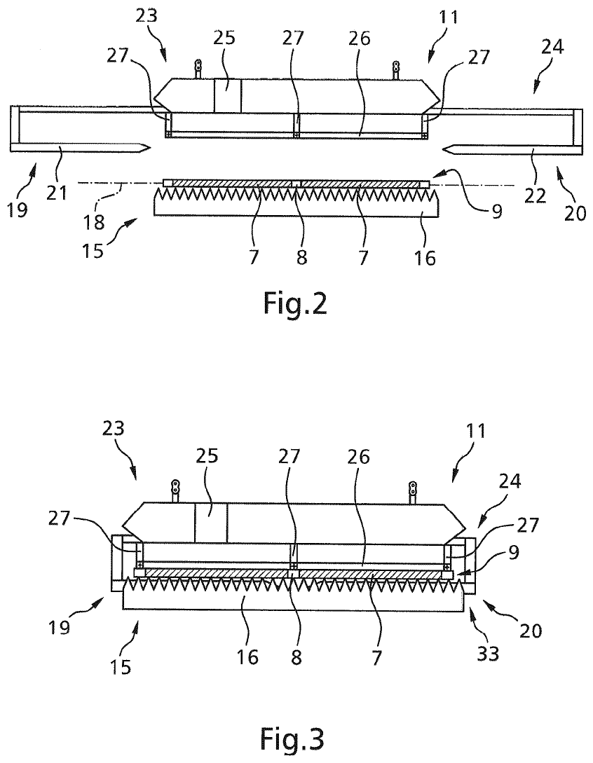

In FIG. 1, the pallet 4 with the residual grid assembly of parts 9 is still inside the working region 5 of the machine tool 3. After the pallet 4 and the residual grid assembly of parts 9 resting on it have been transferred to the pallet changer 10, the conditions shown schematically in FIG. 2 result.

FIG. 2 shows a schematic side view of the workpiece support 15. This workpiece support 15 comprises or consists of multiple support strips 16 arranged one behind the other. Advantageously, these support strips 16 extend parallel to one another and are aligned at a predetermined distance from one another. The residual grid assembly of parts 9 is mounted on the tips of the support strips 16. This is shown schematically in a further side view as shown in FIG. 3. The at least one workpiece 7 and the residual grid 8 of the residual grid assembly of parts 9 lie in a horizontal workpiece plane 18, which is indicated by a dotted line in FIG. 2.

The handling device 11 is moved into a position above the pallet changer 10 or the pallet 4. Rear-engaging elements 19, 20 are movably arranged on a support frame 23 of the handling device 11. These rear-engaging elements 19, 20 are preferably designed to be rake-like and have tines 21, 22 lying one behind the other perpendicular to the drawing plane of FIG. 2 with intermediate spaces. The rear-engaging elements 19, 20 are positioned in an open position or a non-engagement position relative to the support frame 23 according to FIG. 2. Together, the rake-like rear-engaging elements 19, 20 form a rear-engagement device 24 of the handling device 11. A schematically illustrated rake drive 25 on the support frame 23 is used to move the rake-like rear-engaging elements 19, 20.

A holding-down element 26 is provided on the support frame 23 of the handling device 11. This holding-down element 26 is positioned at a distance from the support frame 23. Advantageously, at least one holding element 27 is provided on the support frame 23. This holding element 27 receives the holding-down element 26 in a separable, in particular replaceable, manner. The holding-down element 26 can be designed as a holding-down plate. The holding-down element 26 can be in one piece or comprise or consist of multiple sections, which are, however, arranged in a common plane relative to the support frame 23. The holding elements 27 can be arranged as spring-loaded with respect to the support frame 23. This allows the holding-down element 26 to exert a relative movement in the direction of the support frame 23. The spring bearing is designed such that, in an arrangement of the handling device 11 as shown in FIG. 2, the holding-down element 26 is positioned away from the residual grid assembly of parts 9 by a predetermined or maximum distance with respect to the support frame 23.

The handling device 11 in its entirety shown in FIG. 2 can be moved up and down or displaced in a vertical direction relative to the pallet changer 10 or to the pallet 4 by means of a drive motor 31 recognizable in FIG. 1. FIG. 1 also shows a chassis 32 of the handling device 11, which supports the support frame 23 with its attachments in a vertically movable manner and which, for its part, can be moved by a motor drive on the linear unit 13 of the automation unit 12.

In order to discharge the residual grid assembly of parts 9, the handling device 11 is lowered into the position shown in FIG. 3 with the rear-engaging elements 19, 20 open. In this context, the holding-down element 26 is moved from above onto the residual grid assembly of parts 9. The lowering movement is preferably continued until the holding-down element 26 is positioned resting at least on the residual grid assembly of parts 9. Preferably, the holding-down element 26 is positioned resting on the residual grid assembly of parts 9 with a contact force. In this case, the holding-down element 26 is retracted towards the support frame 23 along a predetermined spring travel due to the spring bearing.

After the holding-down element 26 rests on the residual grid assembly of parts 9, the rear-engaging elements 19, 20 are positioned at a level slightly below the bottom side of the residual grid assembly of parts 9.

Starting from the position of the handling device 11 shown in FIG. 3, the rear-engaging elements 19, 20 are moved against one another by means of the rake drive 25 and transferred into a gripping position 33. In the gripping position 33 of the rear-engaging elements 19, 20, the residual grid assembly of parts 9 is positioned between the tines 21, 22 on the one hand and the holding-down element 26 on the other.

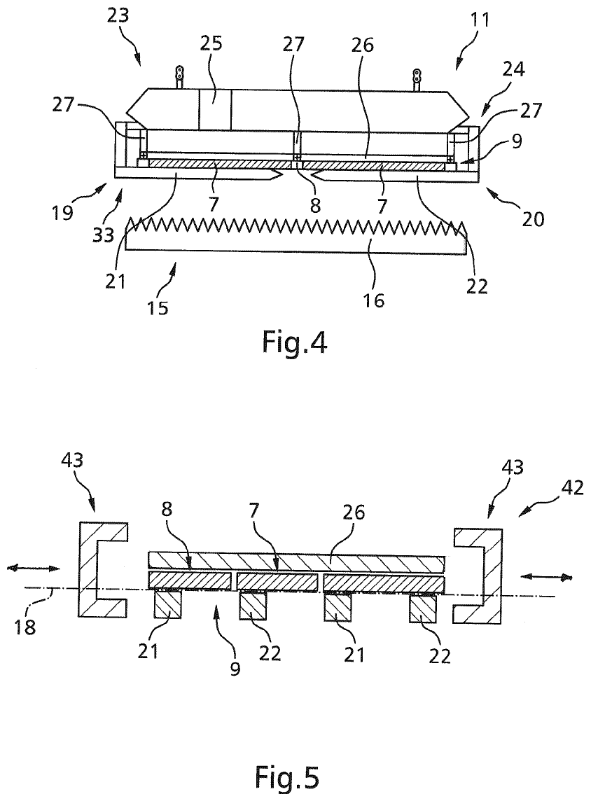

The handling device 11 is then moved upwards by means of the lift drive motor 31. In a first lifting phase, the rear-engaging elements 19, 20 engage on a bottom side of the residual grid assembly of parts 9. Due to the holding-down element 26, which is preferably arranged with a retracted spring travel, this holding-down element 26 remains held resting against the upper side of the residual grid assembly of parts 9 during the first lifting phase so that the residual grid assembly of parts 9 is then held clamped between the holding-down element 26 and the rear-engaging elements 19, 20. This makes it possible, as can be seen from the side view according to FIG. 4, for both the residual grid 8 and the at least one workpiece 7 of the residual grid assembly of parts 9 to remain aligned in a defined position relative to the holding-down element 26. This can prevent the at least one workpiece 7 from tilting relative to the residual grid 8.

In this position of the residual grid assembly of parts 9 held clamped between the holding-down element 26 and the rear-engaging elements 19, 20, the residual grid assembly of parts 9 can be safely lifted off or removed from the workpiece support 15. In FIG. 4, the handling device 11 with the residual grid assembly of parts 9 is shown as lifted relative to the workpiece support 15. Here, the residual grid assembly of parts 9 is held between the holding-down element 26 and the rear-engaging elements 19, 20 or the tines 21, 22, as shown in FIG. 5.

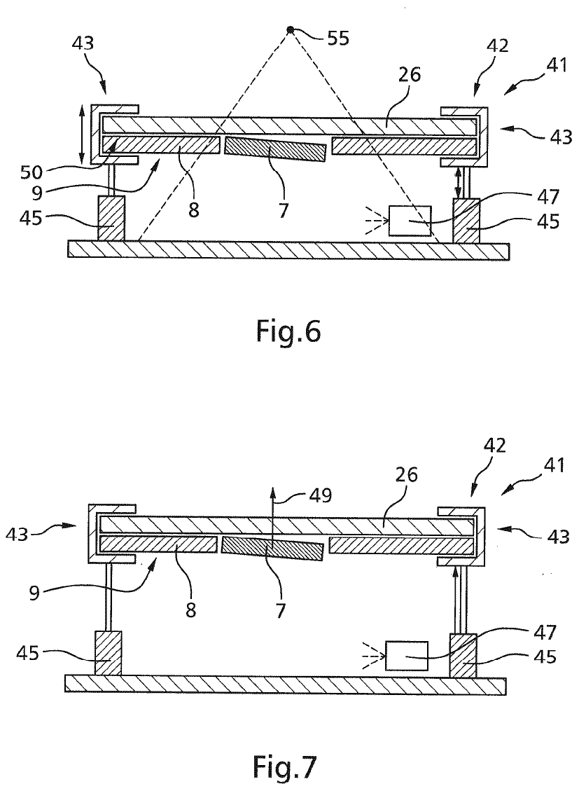

The residual grid assembly of parts 9 lifted from the workpiece support 15 is fed by the handling device 11 to a separating device 41 shown in FIGS. 6 to 11. In this regard, the residual grid assembly of parts 9 and the holding-down element 26 resting on it are transferred together as a unit to the separating device 41. This can be achieved by means of gripping elements or a holder 42 that can be inserted into the separating device 41. Subsequently, in the separating device 41, the at least one workpiece 7 is separated from the residual grid 8 and separated in a downward direction only in a targeted manner.

FIG. 6 shows a schematic side view of the separating device 41. This separating device 41 is shown in a very simplified form. The separating device 41 comprises a holder 42. The holder 42 keeps the residual grid assembly of parts 9 and the holding-down element 26 resting on it aligned with one another. The holder 42 can be formed by clamping elements 43. These can open and close. A clamping force can also be applied so that the holding-down element 26 is held firmly in place resting on the residual grid assembly of parts 9. Alternatively, a defined distance can be provided between the holder and the holding-down element, for example by means of a damping element 50.

The separating device 41 furthermore has a vibration drive 45. In this exemplary embodiment, the vibration drive 45 comprises or consists of at least two linear drive devices. Preferably, a linear drive device engages the at least one clamping element 43 of the holder 42 in each case. At least one detection device 47 is preferably provided below the holder 42. This detection device 47 can be a sensor system or a light barrier or the like. The workpieces 7 separated from the residual grid assembly of parts 9 are detected by this detection device 47. Alternatively, the separating device 41 can be arranged on a manipulator 55 so as to be freely movable.

In the following, on the basis of FIGS. 6 to 9, a separating process of the separating device 41 is described in more detail, by means of which the at least one workpiece 7 is separated from the residual grid 8 of the residual grid assembly of parts 9 in a downward direction in a targeted manner.

In the arrangement shown in FIG. 6, the workpiece 7 is cut completely free relative to the residual grid 8, but is held in a jammed position relative to the residual grid. The vibration drive 45 applies a back and forth movement or vibrations to the holder 42, which is or are perpendicular to the plane of extension of the residual grid assembly of parts 9 and the holding-down element 26.

FIG. 7 shows a vibration excitation in which the holder 42 is moved vertically upwards. A downward movement of the holder 42 is then initiated, in particular vertically downwards. Due to the inertia of the workpiece 7 as shown by the arrow 49, the reversal of direction of the traversing movement causes the workpiece 7 to come into contact with the holding-down element 26, thereby resting against it.

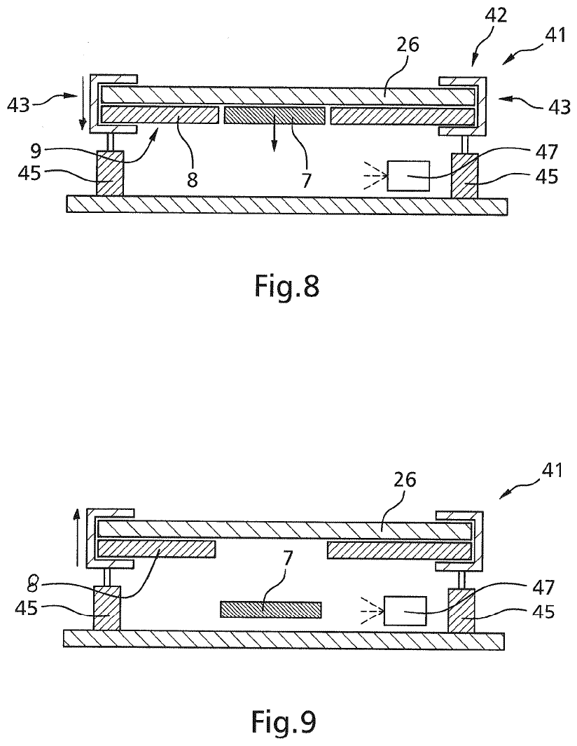

The workpiece 7 resting against the holding-down element 26 is shown in FIG. 8. The acceleration of the holder 42 vertically downwards also moves the workpiece 7 downwards. By a further reversal of direction of the holder in the upward direction, the workpiece is separated in a downward direction in a targeted manner as shown in FIG. 8.

This up and down movement of the holder 42 or the oscillation of the holder 42 can be repeated multiple times until the workpiece 7 or the workpieces 7 is/are separated from the residual grid 8. The detection device 47 detects the number of workpieces 7 separated so that the vibration drive 45 is either stopped after a predetermined time or immediately after all workpieces 7 to be separated have been detected by the detection device 47. FIG. 9 shows the end of the separating process after the workpiece 7 has been separated from the residual grid 8.

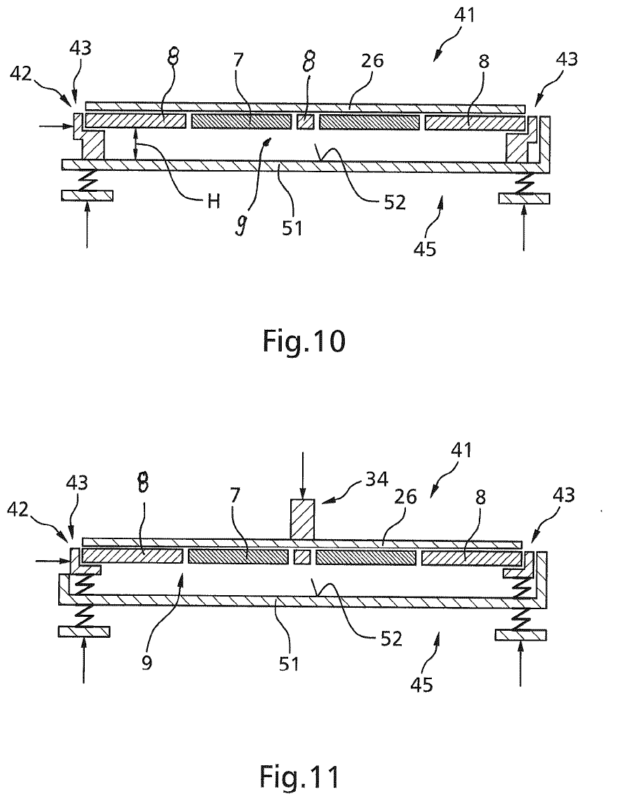

FIG. 10 shows an alternative embodiment of the separating device 41. In this embodiment, the vibration drive 45 is designed as a vibration conveyor. This vibration conveyor comprises a conveying trough 51 with a base 52. The conveying trough 51 is excited to vibrate by means of vibrating devices. Within the trough 51, the holder 42 is provided for receiving the residual grid assembly of parts 9 and the holding-down element 26. The holder 42 can be adjustable to different formats of the residual grid assembly of parts 9.

In this embodiment, a distance H is preferably provided between a bottom side of the residual grid assembly of parts 9 and the base 52 of the conveying trough 51 of the vibration conveyor, which corresponds at least to the thickness of the residual grid assembly of parts 9 to be separated. This allows the workpiece 7 to be removed safely.

FIG. 11 shows a schematic side view of an alternative embodiment of the separating device 41 compared to FIG. 10. In this embodiment, at least one vibration tool 34 is used in addition to the vibration drive 45. This vibration tool 34 can be attached to an upper side of the holding-down element 26. This allows an additional vibration excitation to be introduced into the holding-down element 26, which is advantageously transmitted to the entire residual grid assembly of parts 9. This vibration tool 34 can increase the effectiveness of the separating process for separating the at least one workpiece 7 from the residual grid 8. Alternatively, multiple vibration tools 34 can also be used. These can be positioned both on the upper side of the holding-down element 26 and on an end face.

Such a vibration tool 34 can be, for example, a vibrating head or a lifting piston vibrator, a piezo element or the like.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for separating at least one workpiece from a residual grid of a residual grid assembly of parts which is produced from a plate-shaped material by a cutting process, the method comprising:
feeding the residual grid assembly of parts to a holder of a separating device together with a holding-down element resting on an upper side of the residual grid assembly of parts; and
jointly exciting and thereby vibrating the holding-down element and the residual grid assembly of parts by a vibration drive,
wherein the holding-down element is configured to enable the at least one workpiece to be separated in a targeted manner only downward with respect to a bottom side of the residual grid assembly of parts.

2. The method according to claim 1, wherein the holding-down element and the residual grid assembly of parts are held together resting against one another by the holder in a clamped manner.

3. The method according to claim 1, wherein at least one linear drive movement is generated by the vibration drive, the linear drive movement being aligned independently of direction.

4. The method according to claim 1, wherein the at least one workpiece is initially tilted or jammed in the residual grid and is aligned by an inertial force resting against the holding-down element by at least one reversal of direction of a generated vibration and is subsequently guided downwards out of the residual grid by gravity and/or a subsequent reversal of direction.

5. The method according to claim 1, wherein a detector is provided positioned below the residual grid assembly of parts, the detector being configured to detect the at least one workpiece separated from the residual grid.

6. The method according to claim 5, wherein the vibration drive is activated until the detector detects the separation of the at least one workpiece from the residual grid.

7. The method according to claim 1, wherein the vibrations of the vibration drive are applied directly to the holder in each case to clamping elements or tensioning elements of the holder.

8. The method according to claim 1, wherein the vibrations of the vibration drive are introduced into the holding-down element from above or into the residual grid assembly of parts from below.

9. The method according to claim 1, wherein the vibration drive is configured as a direction-independent drive.

10. The method according to claim 1, wherein the vibration drive is configured as a vibration conveyor, by which the at least one workpiece separated from the residual grid is conveyed away.

11. The method according to claim 1, wherein the holding-down element and/or the residual grid assembly of parts are excited to vibrate using an additional vibration tool.

12. A separating device for separating at least one workpiece from a residual grid of a residual grid assembly of parts which can be produced in a machine tool from a plate-shaped material by a cutting process, the separating device configured to carry out a method including:
feeding the residual grid assembly of parts to a holder of the separating device together with a holding-down element resting on an upper side of the residual grid assembly of parts; and
jointly exciting and thereby vibrating the holding-down element and the residual grid assembly of parts by a vibration drive,
wherein the holding-down element is configured to enable the at least one workpiece to be separated in a targeted manner only downward with respect to a bottom side of the residual grid assembly of parts, and
wherein the residual grid assembly of parts and the holding-down element are configured to be arranged by the holder.

13. The separating device according to claim 12, wherein the holder is formed by clamping elements or tensioning elements, by which the holding-down element is held resting on the residual grid assembly of parts in a clamped manner.

14. The separating device according to claim 12, wherein a defined distance is provided between the holder and the holding-down element by a damping element.

15. The separating device according to claim 12, wherein the vibration drive is configured as a linear drive or as a vibration conveyor.

16. The separating device according to claim 15, wherein the vibration drive is configured as the vibration conveyor that receives the holder above a base of a conveying trough, and wherein the holder is arranged above the base at a distance of at least a thickness of the residual grid assembly of parts to be separated.

17. The separating device according to claim 12, wherein the separating device is arranged to be freely movable on a manipulator.

18. The method according to claim 1, wherein at least one linear drive movement is generated by the vibration drive, the linear drive movement being aligned in a direction perpendicular to a flat plane of extension of the residual grid assembly of parts.
